(19) United States
(12) Patent Application Publication
(10) Pub. No.: US 2007/0130249 A1
(43) Pub. Date: Jun. 7, 2007

(54) WIRELESS COMMUNICATION APPARATUS AND METHOD, AND WEB BROWSER USING THE APPARATUS

(75) Inventor: Zing-Wei Kang, Taipei City (TW)

Correspondence Address: SNELL & WILMER L.L.P. (Main), 400 EAST VAN BUREN, ONE ARIZONA CENTER, PHOENIX, AZ, 85004-2202, US

(73) Assignee: BENQ CORPORATION, Taoyuan (TW)

(21) Appl. No.: 11/565,962

(22) Filed: Dec. 1, 2006

(30) Foreign Application Priority Data
Dec. 2, 2005 (TW) 94142690

(51) Int. Cl. G06F 15/16

(52) U.S. Cl. 709/202

(57) ABSTRACT

A wireless communication apparatus and method, and a web browser using the apparatus are disclosed. The wireless communication apparatus is configured to communicate with a wireless base station. The wireless communication apparatus includes a communication unit, a switch unit, and an adjustment unit. The switching unit repeatedly switches the wireless communication apparatus from a sleeping mode to a listening mode after a listening interval, and the communication unit is able to communicate with the wireless base station during the listening mode. When the wireless communication apparatus performs a data access process with the wireless base station, the adjusting unit adjusts the listening interval to a first interval. After the wireless communication apparatus completes the data access process with the wireless base station, the adjusting unit adjusts the listening interval to a second interval, wherein the second interval is smaller than the first interval.

### CROSS REFERENCE TO RELATED APPLICATIONS

This application claims priority of Taiwan Patent Application Serial No. 094142690 entitled “Wireless Communication Apparatus and Method, and Web Browser Using the Apparatus,” filed on Dec. 2, 2005.

### FIELD OF THE INVENTION

The present invention relates to a wireless communication apparatus and method, particularly to a wireless communication apparatus and method for saving energy consumption by adjusting a listening interval.

### BACKGROUND OF THE INVENTION

In recent years, an increasing demand has emerged for mobile communication; thus, the wireless communication and wireless network are gaining more importance recently and have been applied to a variety of consumer electronic products, such as notebook, personal digital assistant, smart phone, and the like. In addition to the issues of the bandwidth and security of the data transmission, the power consumption is another important issue regarding wireless communication. Efficient power management could greatly improve the convenience and practicability of the wireless communication products.

Some power management schemes have been disclosed in order to reduce the power consumption. Taking the standard wireless network of 802.11 as an example, a sleeping mode is used to reduce the power consumption. FIG. 1 illustrates an ordinary wireless communication method between the wireless base station 102 and the wireless communication apparatus 104, wherein the horizontal axis represents time. In a traditional structure, the wireless base station 102 repeatedly sends a beacon after a predetermined interval, or namely a beacon interval. The wireless communication apparatus 104 stays in a sleeping mode for power saving and repeatedly wakes up to a transmission mode after a fixed interval for receiving the beacon from the wireless base station 102.

Referring to FIG. 1, the wireless communication apparatus 104 switches to the transmission mode at a time t2 for receiving the beacon from the wireless base station 102. After the wireless communication apparatus 104 submits a data request 110 to the wireless base station 102, it enters into sleeping mode again. The wireless base station 102 obtains the data for the wireless communication apparatus 104 at a time t3, and then sends a beacon indicating that the requested data are available. The wireless communication apparatus 104 wakes up to the transmission mode for receiving the beacon after sleeping for a listening interval (i.e. twice of the predetermined interval in this case). The wireless communication apparatus 104 receives the beacon and finds that the requested data are available, and then the transmission of the requested data from the wireless base station 102 begins. The wireless communication apparatus 104 sends a signal 112 to request the data transmission, and then the wireless base station 102 sends the data 114 to the wireless communication apparatus 104. The wireless communication apparatus 104 turns into the sleeping mode again after the transmission is completed.

In the traditional method described above, the wireless base station 102 communicates with the wireless communication apparatus 104 through the beacon, and the wireless communication apparatus 104 reduces its power consumption by entering into the sleeping mode. Although it indeed saves a part of power consumption, the power consumption increases even more while the demand for wireless communication becomes larger and the wireless communication apparatus becomes more powerful. The traditional power management is unable to provide more efficient power management according to the operation habit of the users and the actual operation conditions.

Therefore, it is advantageous to provide a wireless communication apparatus and method for reducing the power consumption according to different operation conditions.

### SUMMARY OF THE INVENTION

One aspect of the present invention is to provide a wireless communication apparatus and a method for saving energy consumption by adjusting a listening interval and a web browser using the wireless communication apparatus.

A wireless communication apparatus is configured to communicate with a wireless base station in accordance with one embodiment of the present invention. The wireless communication apparatus includes a switching unit, a communication unit and an adjusting unit. The switching unit repeatedly switches the wireless communication apparatus from a sleeping mode to a listening mode after a listening interval. The communication unit is configured to communicate with the wireless base station during the listening mode. The adjusting unit adjusts the listening interval to a first interval when the wireless communication apparatus performs a data access process with the wireless base station. The adjusting unit adjusts the listening interval to a second interval after the wireless communication apparatus completes the data access process with the wireless base station. The second interval is smaller than the first interval.

A wireless communication method is applied to a wireless communication apparatus in accordance with another embodiment of the present invention. The method comprises: setting a listening interval for enabling the wireless communication apparatus repeatedly switching from a sleeping mode to a listening mode, the wireless communication apparatus communicating with a wireless base station during the listening mode; adjusting the listening interval to a first interval when the wireless communication apparatus performs a data access process with the wireless base station; and adjusting the listening interval to a second interval after the wireless communication apparatus completes the data access process with the wireless base station. The second interval is smaller than the first interval.

A web browser is applied to a wireless communication apparatus in accordance with still another embodiment of the present invention. The web browser includes a core module, a communication module and a monitor module. The core module is configured to process a webpage access request. The communication module is configured to drive the wireless communication apparatus. The monitor module is configured to monitor a frequency of the webpage access request sent by the core module. The monitor module sends a signal to the communication module according to the frequency to enable the wireless communication apparatus to repeatedly switch from a sleeping mode to a listening mode. The wireless communication apparatus communicates with a wireless base station during the listening mode.

### BRIEF DESCRIPTION OF THE DRAWINGS

FIG. 1 illustrates an conventional wireless communication method;

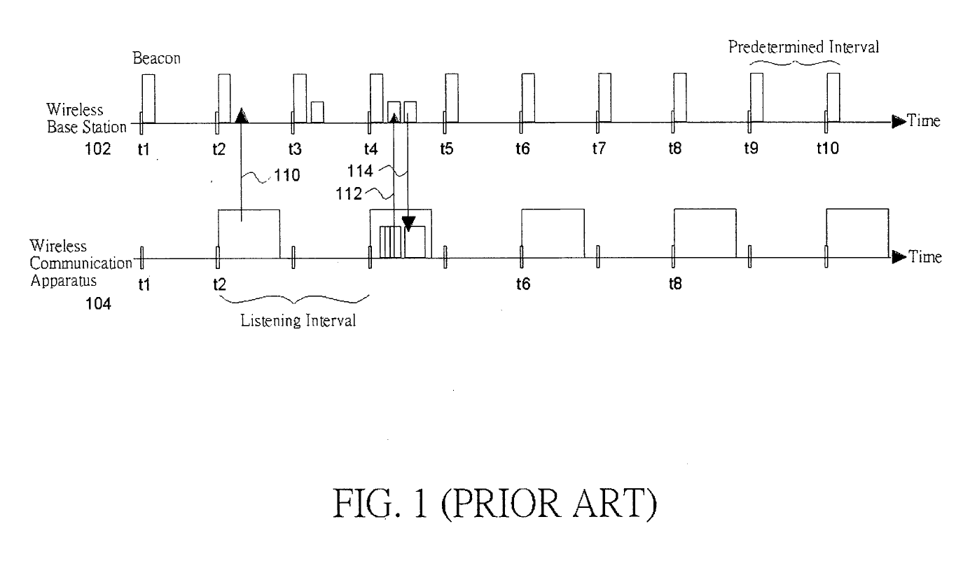

FIG. 2 illustrates a wireless communication apparatus in accordance with one embodiment of the present invention;

FIG. 3 illustrates a wireless communication method in accordance with one embodiment of the present invention;

FIG. 4 illustrates a wireless communication method in accordance with another embodiment of the present invention; and

FIG. 5 illustrates a web browser in accordance with one embodiment of the present invention.

### DETAILED DESCRIPTION OF THE INVENTION

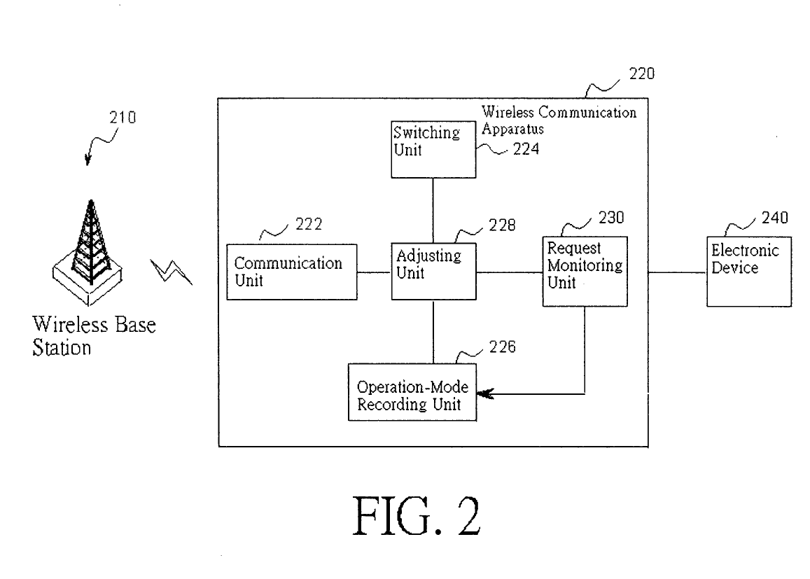

FIG. 2 illustrates a wireless communication apparatus 220 configured to communicate with a wireless base station 210 in accordance with one embodiment of the present invention. The term “communication” hereinafter includes sending an access request, transmitting data, receiving data, or the like. The communication between wireless communication apparatus 220 and wireless base station 210 may be performed based on any wireless communication protocol and still be applied to the present invention. The wireless communication protocol of IEEE 802.11 is used in this embodiment. The wireless communication apparatus 220 includes a communication unit 222, a switching unit 224, an operation-mode recording unit 226, an adjusting unit 228, and a web request monitoring unit 230. In this embodiment, wireless communication apparatus 220 is connected to an electronic device 240, such as a personal computer or a notebook. The electronic device 240 communicates with the wireless base station 210 through the wireless communication apparatus 220, and then connects to a remote network, such as Internet (not shown). The wireless communication apparatus 220 is selectively in a sleeping mode and a listening mode. In the sleeping mode, the wireless communication apparatus 220 keeps a minimum power for basic operations, and in the listening mode, the wireless communication apparatus 220 restores power to all or most of components therein for receiving signals from or even further communicating with the wireless base station 210.

The wireless base station 210 repeatedly sends a beacon after a predetermined interval, or namely a beacon interval. The switching unit 224 repeatedly switches the wireless communication apparatus 220 from the sleeping mode to the listening mode after a listening interval. Meanwhile, the communication unit 222 receives the beacon from the wireless base station 210. The communication unit 222 may include an antenna, a signal transmitter, a transponder, or the like.

In this embodiment, when a user submits an access request to a web site within Internet through the electronic device 240, the access request will be monitored by the web request monitoring unit 230 of the wireless communication apparatus 220 and recorded in the operation-mode recording unit 226. For determining the user's operation mode, information recorded in the operation-mode recording unit 226 may include a frequency of the web access request sent by the user, domain of the requested webpage, type of the requested webpage, username, identification code, or other information related to the operation of the user. In this embodiment, the operation-mode recording unit 226 is configured to record a count of the data access request performed by the wireless communication apparatus 220 in response to the user per unit time. Details of the operation mode of the user will be discussed later.

The adjusting unit 228 adjusts the listening interval according to the information of operation mode recorded in the operation-mode recording unit 226. In this embodiment, adjusting unit 228 adjusts the listening interval to a first interval when the wireless communication apparatus performs a data access process with the wireless base station 210. The adjusting unit 228 adjusts the listening interval to a second interval after the wireless communication apparatus completes the data access process with the wireless base station, wherein the second interval is smaller than the first interval.

In another embodiment, the listening interval may be configured to depend on other requirements. For example, the listening interval may be configured between a maximum value and a minimum value, and the listening interval is a multiple of the predetermined interval. Furthermore, the maximum and the minimum values of the listening interval may also be modified case-by-case. In this embodiment, the maximum value of the listening interval is five times the predetermined interval and the minimum value of the listening interval is equal to the predetermined interval. Further, in this embodiment, the adjusting unit 228 enlarges the listening interval when the frequency of the web access request becomes higher. Contrarily, the adjusting unit 228 reduces the listening interval when the frequency of the web access request becomes lower. The adjusting unit 228 may also adjust the listening interval according to other criteria besides the frequency. Details of the adjustment will be discussed later.

When the communication unit 222 receives the beacon indicating the requested data being buffered in the wireless base station 210, the communication unit 222 starts to receive the data from the wireless base station 210. Contrarily, when the communication unit 222 receives the beacon indicating no requested data being presented in the wireless base station 210, or when the data transmission has been completed, the adjusting unit 224 adjusts the wireless communication apparatus 220 from the listening mode to the sleeping mode. It should be noted that the above described embodiment should be understood as an example of the present invention rather than a limitation. The wireless communication apparatus 220 can be integrated with the external electronic device 240 to be, for example, a personal digital assistant or a smart phone equipped with the wireless communication function. Or in still another embodiment, the wireless communication apparatus 220 may communicate with another mobile device for providing local data sharing rather than Internet accessing. In this embodiment, the webpage accessing is recited as an example for illustrative purpose, but the present invention is not limited thereto.

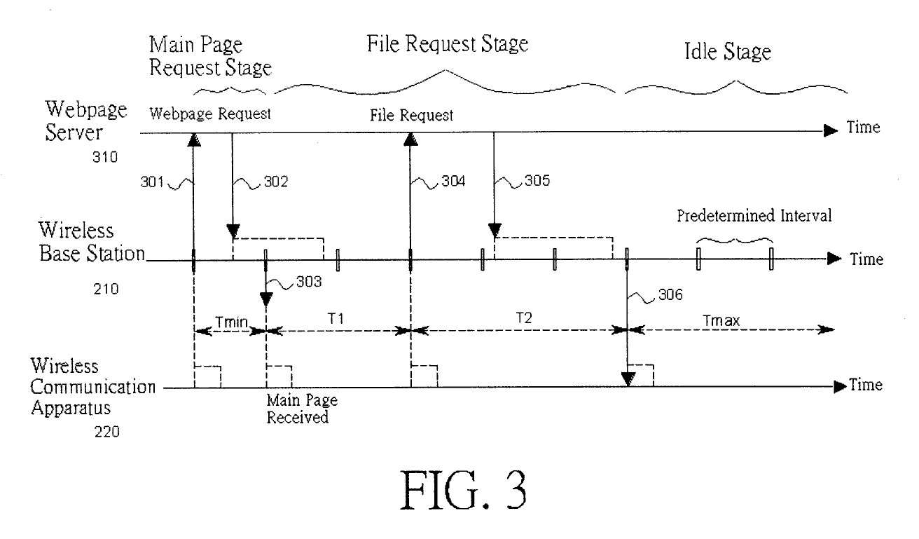

FIG. 3 illustrates a wireless communication method showing the communication among the wireless communication apparatus 220, the wireless base station 210 and the webpage server 310 in accordance with one embodiment of the present invention. In this embodiment, a user submits a webpage request through the wireless communication apparatus 220. The webpage request generally includes three stages, namely a main page request stage, a file request stage and an idle stage. For example, a data access process is performed when the user submits a webpage access request 301 through the wireless communication apparatus 220 to the webpage server 310. The webpage server 310, in response to the request, will send the main page at first, or namely the homepage, such as “index.html” (shown as arrow 302), and the wireless base station 210 will buffer the data for this data access process. When the wireless communication apparatus 220 receives the main page from the wireless base station 210 (shown as arrow 303), the file request stage begins. In file request stage, the wireless communication apparatus 220 requests various files associated with the main page (shown as arrow 304), such as image file, audio file, multimedia file, or other executable file. These files will be transferred to the wireless base station 210 from the webpage server 310 (shown as arrow 305), and then be transferred to the wireless communication apparatus 220 from the wireless base station 210 (shown as arrow 306). When the file transfer is finished, the idle stage begins. As discussed above, a traditional wireless communication method uses a fixed listening interval for a static sleeping schedule. The listening interval is constant regardless of the operation mode of the user and the transfer stage of webpage request. However, the present invention may adjust the listening interval according to the operation mode of the user, for example, the first interval and the second interval described above.

In another embodiment of the present invention, the listening interval may be further adjusted case-by-case. For example, the data access process may further include an item access process and a content access process. The adjusting unit adjusts the listening interval to a third interval when the wireless communication apparatus performs the item access process with the wireless base station. The adjusting unit adjusts the listening interval to a fourth interval when the wireless communication apparatus performs the content access process with the wireless base station, wherein the third interval is smaller than the fourth interval. In this embodiment, the wireless communication apparatus 220 submits a main page access request to the wireless base station 210 during the item access process and submits various file requests during the content access process. The adjustment of the listening interval is now described in more details as following for better understanding of the present invention. After the user submits a webpage access request through the wireless communication apparatus 220, it is naturally expected for the user to receive the main page as soon as possible. Therefore, the listening interval 228 is adjusted to a minimum value Tₘᵢₙ, i.e. equal to the predetermined interval, in order to obtain the main page quickly. During the file request stage, the user may read the received main page to determine whether this webpage contains information in which they are interested, even if the remaining files associated with the webpage are still unavailable. In this case, the adjusting unit 228 may slightly increase the listening interval for power saving. For example, the listening interval is adjusted to be twice of the predetermined interval, namely T₁. The wireless communication apparatus 220 may further adjust the listening interval according to the operation mode of the user. For example, the adjusting unit 228 adjusts the listening interval to T₂ according to the operation mode of the user as shown in FIG. 3. After all of the requested files are completely transferred, the idle stage begins if no further webpage access request is submitted by the user. During the idle stage, the adjust unit 228 adjusts the listening interval to a maximum value Tₘₐₓ for further power saving. In this embodiment, the web request monitoring unit 230 of the wireless communication apparatus 228 is configured to monitor the frequency of the webpage access request sent by the user, and the operation-mode recording unit is configured to record the frequency of the webpage access request sent by user during a recent period of time, e.g. frequency within five minutes. Therefore, the adjusting unit 228 may adjust the listening interval according to the latest operation mode of the user. It should be noted that the maximum value of the listening interval is smaller than or equals to a buffer period for the wireless base station 220 buffering data from the webpage server 310 to avoid data lost. For example, if the wireless base station 210 buffers the data requested by the user for a period of ten determined intervals, the wireless communication apparatus 220 is allowed to adjust the listening interval up to at most ten determined intervals.

Furthermore, the operation mode of the user may be determined in various ways. For example, if the user is not interested in the received webpage, it is very likely for him to submit a new webpage access request immediately. It causes the increasing frequency of the webpage access request. Since the increasing frequency indicates that the user merely skims through these webpages and the associated files are likely to be unnecessary, the adjusting unit 228 may enlarge the listening interval to postpone the file access request and transfer. Therefore, unnecessary file access requests and transfers may be avoided when the user submits the webpage access request at a relatively high frequency. Conversely, a decreasing frequency indicates that the user is interested in these webpages, so that the associated files are possibly important. As a result, the adjusting unit 228 reduces the listening interval to accelerate the file access request and transfer.

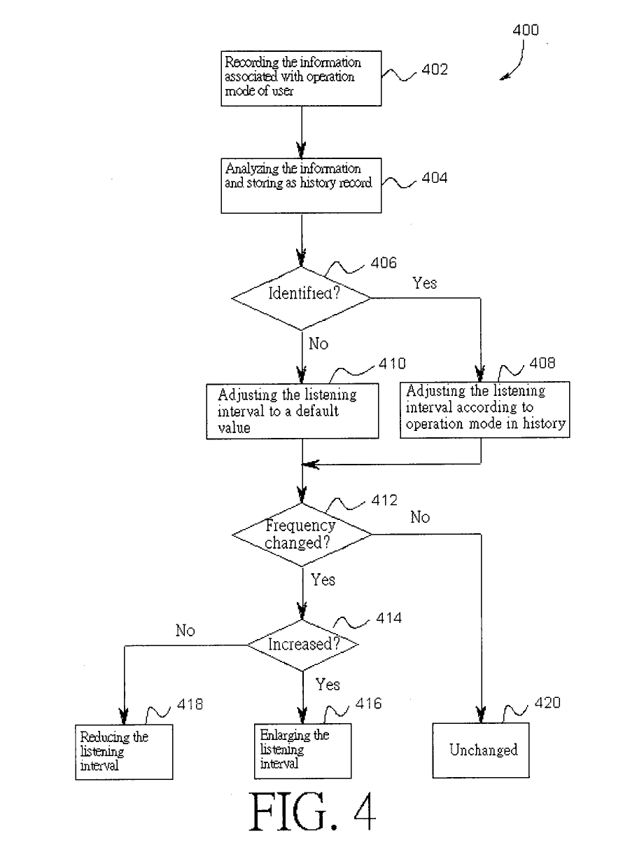

FIG. 4 illustrates a wireless communication method 400 in accordance with another embodiment of the present invention. In step 402, information associated with the operation mode of the user is recorded through, for example, the operation-mode recording unit 226 in FIG. 2. In step 404, the recorded information is analyzed and stored as a history record for future use. For example, the adjusting unit 228 may utilize the history record as a reference for adjustment of listening interval. Information analysis may be performed based on various approaches, such as being classified according to domain of the requested webpage, type of the requested webpage, username, identification code, or other characteristics. By means of this classification, the operation mode of the user may be identified in various situations. Considering an exemplary situation, a user may have a relative high accessing frequency to a website A and a relative low accessing frequency to a website B. The adjusting unit 228 may adjust the listening interval in different strategies with respect to website A and website B for a even better power management. In another embodiment, each user may have his own history record of operation mode so that the adjusting unit 228 may adjust the listening interval to fulfill different operation habits for different users. It may further provide a flexible and efficient power management for wireless communication.

In step 406, when the user submits a new webpage access request, whether the requested webpage can be identified in the history records is determined. If the history records contain information regarding the requested webpage, the listening interval is adjusted according to operation mode in the history records in step 408. If the webpage is not identified in the history records, the listening interval is adjusted to a default value in step 410. In other embodiments of the present invention, a single default value may be applied to every webpage unidentified in the history records, or alternatively, multiple default values may be applied to different webpages unidentified in the history records, for example, according to the domain or physical location of the website.

In step 412, whether the frequency of file access request is changed is determined, for example, according to the method described in FIG. 3. If the accessing frequency is unchanged, the listening interval is not adjusted in step 420. If the accessing frequency is changed, whether the frequency is increasing is determined in step 414. If the accessing frequency is increasing, the listening interval is enlarged in step 416. Otherwise, if the accessing frequency is decreasing, the listening interval is reduced in step 418. In other words, when the wireless communication apparatus 220 performs the data access process to the wireless base station 210, e.g. submitting a webpage access request, the adjusted listening interval is proportioned to a count of the data access process by the wireless communication apparatus 220 per unit time.

As discussed above, comparing to the static power management in the prior art, the present invention provides a dynamic power management according to the operation mode of the user. The listening interval is dynamically adjusted so that the power consumption is further effectively managed.

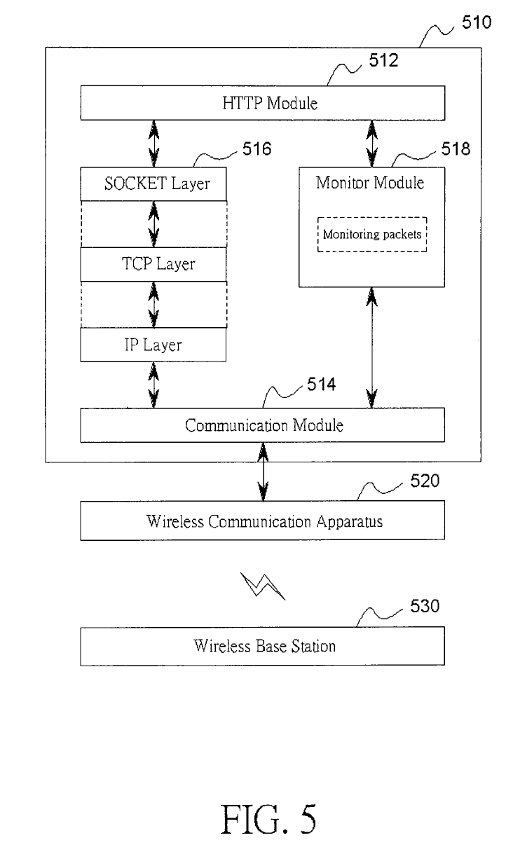

FIG. 5 illustrates a web browser 510 in accordance with one embodiment of the present invention. The web browser 510 communicates with a wireless base station 530 through a wireless communication apparatus 520. The wireless base station 530 repeatedly sends a beacon after a predetermined interval, and the details of communication between the wireless communication apparatus 520 and wireless base station 530 may refer to the embodiments described above with reference to FIG. 2 and FIG. 3. In this embodiment, the web browser 510 is implemented as a software application configured to perform on an electronic device (not shown), such as a personal computer, other than the wireless communication apparatus 520. In another embodiment, the web browser 510 and the wireless communication device 520 may be integrated into a single hardware device, such as a personal digital assistant. That is, the web browser 510 may be implemented as various embodiments in accordance with the present invention, including software/hardware in the form of standalone/integrated type.

Referring to FIG. 5, the web browser 510 includes a core module 512, a communication module 514, a protocol module 516, and a monitor module 518. In this embodiment, the core module 512 is a HTTP module for processing a webpage access request, such as transmitting and receiving. The communication module 514 is configured to drive and communicate with the wireless communication apparatus 520. The protocol module 516 is coupled to the core module 512 and the communication module 514 according to a predetermined protocol. In this embodiment, the protocol module 516 applies the TCP/IP protocol, including SOCKET layer, TCP layer and IP layer, for processing data packets from the core module 512 or from the communication module 514. Other details of the protocol are well known to those who skilled in the art, and are thus omitted here for conciseness. In addition, the protocol module 516 may apply any other protocol without limitation.

The monitor module 518 is configured to monitor information associated with the webpage access request sent from the core module 512, thus an operation mode of the user may be identified. For example, the monitor module 518 monitors a frequency of the webpage access request sent by the core module 512, or optionally classifies the information associated with the operation mode according to domain of the requested webpage, type of the requested webpage, username or identification code. The monitor module 518 sends a signal to the communication module 514 to enable the wireless communication apparatus 520 to adjust a listening interval. The wireless communication apparatus 520 repeatedly switches from a sleeping mode to a listening mode according to the listening interval. Other details of adjustment of the listening interval may refer to the embodiments described above with reference to FIG. 2 and FIG. 3, and are thus omitted here for conciseness.

As discussed above, the web browser 510 may easily cooperate with the wireless communication apparatus 520 for dynamically adjusting the listening interval according to the operation mode of the user for power saving. In addition, the monitor module 518 will neither change the main stricture of the web browser 510 nor affect the operation interface to the user, so that the present invention is easily applied and used with strong stability.

The spirit and scope of the present invention can be clearly understood by the above detail descriptions of the prefer embodiments. The embodiments are not intended to limit the scope of the invention. Contrarily, various modifications of the illustrative embodiments, as well as other embodiments of the invention, will be apparent to persons skilled in the art upon reference to this description. It is therefore contemplated that the appended claims will cover any of such modifications or embodiments as falling within the true scope of the invention.

What is claimed is:

1. A wireless communication apparatus configured to communicate with a wireless base station, the wireless communication apparatus comprising:
a switching unit periodically switching the wireless communication apparatus from a sleeping mode to a listening mode according to a listening interval;
a communication unit configured to communicate with the wireless base station during the listening mode; and
an adjusting unit for setting the listening interval to a first interval when the wireless communication apparatus performing a data access process with the wireless base station, and setting the listening interval to a second interval after the data access process completed;
wherein the second interval is smaller than the first interval.

2. The wireless communication apparatus according to claim 1, wherein the listening interval is a multiple of a predetermined interval, and the wireless base station periodically sending a beacon according to the predetermined interval.

3. The wireless communication apparatus according to claim 1, wherein the data access process further includes an item access process and a content access process, the item access process having a link to the content access process, and wherein the adjusting unit sets the listening interval to a third interval when the wireless communication apparatus performing the item access process with the wireless base station, and the adjusting unit sets the listening interval to a fourth interval when the wireless communication apparatus performing the content access process with the wireless base station, and wherein the third interval is smaller than the fourth interval.

4. The wireless communication apparatus according to claim 3, wherein the data access process is a webpage request, and wherein the item access process is a main page request and the content access process is a file request with the link.

5. The wireless communication apparatus according to claim 4, wherein the wireless communication apparatus enters to a sleeping mode when the webpage request is finished.

6. The wireless communication apparatus according to claim 3, further comprising a operation-mode recording unit for recording a count of the data access process performed by the wireless communication apparatus per unit time, and wherein a length of the fourth interval is proportioned to the count.

7. The wireless communication apparatus according to claim 6, wherein information recorded by the operation-mode recording unit is further classified according to at least one of: domain of the requested webpage, type of the requested webpage, username, and identification code.

8. The wireless communication apparatus according to claim 1, wherein the wireless base station is connected to a data server, and the wireless communication apparatus performs the data access process through the wireless base station, and wherein maximum value of the listening interval is not larger than a buffer period for the wireless base station buffering data from the data server.

9. A wireless communication method applied to a wireless communication apparatus, comprising:
setting a listening interval for enabling the wireless communication apparatus to periodically switching from a sleeping mode to a listening mode, the wireless communication apparatus communicating with a wireless base station during the listening mode;
setting the listening interval to a first interval when the wireless communication apparatus performs a data access process with the wireless base station; and
setting the listening interval to a second interval after the data access process completed, the second interval being smaller than the first interval.

10. The wireless communication method according to claim 9, wherein the listening interval is a multiple of a predetermined interval, and the wireless base station periodically sending a beacon according to the predetermined interval.

11. The wireless communication method according to claim 9, wherein the data access process further includes an item access process and a content access process, the item access process having a link to the content access process, and the method further comprising adjusting the listening interval to a third interval when the wireless communication apparatus performs the item access process with the wireless base station; and the adjusting the listening interval to a fourth interval when the wireless communication apparatus performs the content access process with the wireless base station, and wherein the third interval is smaller than the fourth interval.

12. The wireless communication method according to claim 11, wherein the data access process is a webpage request, and wherein the item access process is a main page request and the content access process is a file request with the link.

13. The wireless communication method according to claim 12, further comprising configuring the wireless communication apparatus to enter into the sleeping mode when the webpage request is finished.

14. The wireless communication method according to claim 11, further comprising recording a count of the data access process performed by the wireless communication apparatus per unit time, and wherein a length of the fourth interval is proportioned to the count.

15. The wireless communication method according to claim 14, wherein the recording step further comprising classifying recorded information according to at least one of: domain of the requested webpage, type of the requested webpage, username, and identification code.

16. The wireless communication method according to claim 9, wherein the wireless base station is connected to a data server, and the wireless communication apparatus performs the data access process through the wireless base station, and wherein a maximum value of the listening interval is not larger than a buffer period for the wireless base station buffering data from the data server.

17. A web browser applied to a wireless communication apparatus, comprising:
a core module for processing a webpage access request;
a communication module for driving the wireless communication apparatus;
a monitor module for monitoring a frequency of the webpage access request sent by the core module;
wherein the monitor module sends a signal to the communication module according the frequency to enable the wireless communication apparatus to adjust a listening interval, the wireless communication apparatus repeatedly switching from a sleeping mode to a listening mode according to the listening interval, the wireless communication apparatus communicating with a wireless base station during the listening mode.

18. The web browser according to claim 17, wherein, in response to a instruction from the web browser, the wireless communication apparatus adjusts the listening interval to a first interval when the wireless communication apparatus performs a data access process with the wireless base station, and the wireless communication apparatus adjusts the listening interval to a second interval after the wireless communication apparatus completes the data access process with the wireless base station.

19. The web browser according to claim 18, wherein the data access process further includes an item access process and a content access process, and wherein the wireless communication apparatus adjusts the listening interval to a third interval when the wireless communication apparatus performs the item access process with the wireless base station, and the wireless communication apparatus adjusts the listening interval to a fourth interval when the wireless communication apparatus performs the content access process with the wireless base station, and wherein the third interval is smaller than the fourth interval.

20. The web browser according to claim 17, wherein the data access process is a webpage request, and wherein the item access process is a main page request, and the content access process is a file request.

21. The web browser according to claim 19, wherein the monitor module is configured to record a count of the data access process performed by the wireless communication apparatus per unit time, and wherein a length of the fourth interval is proportioned to the count.

22. The web browser according to claim 17, wherein information recorded by the monitor module is further classified according to at least one of: domain of the requested webpage, type of the requested webpage, username, and identification code.
